(19) United States
(12) Patent Application Publication
(10) Pub. No.: US 2013/0318168 A1
(43) Pub. Date: Nov. 28, 2013

(54) VEHICLE-BASED SOCIAL NETWORKS

(71) Applicants: Jeff Demain, Los Angeles, CA (US); Krystof Zmudzinski, Forest Grove, OR (US); Wendy March, Portland, OR (US)

(72) Inventors: Jeff Demain, Los Angeles, CA (US); Krystof Zmudzinski, Forest Grove, OR (US); Wendy March, Portland, OR (US)

(73) Assignee: Intel Corporation, Santa Clara, CA (US)

(21) Appl. No.: 13/976,347

(22) PCT Filed: Dec. 30, 2011
(86) PCT No.: PCT/US2011/068098

§ 371 Date: Jun. 26, 2013

(51) Int. Cl. H04L 29/08

(52) U.S. Cl. CPC H04L 67/12
USPC 709/204

(57) ABSTRACT

A machine-controlled method can include a first vehicle network node of a user monitoring for a second vehicle network node, detecting the presence of a second vehicle network node within a specified distance from the first vehicle network node, and determining whether the second vehicle network node is associated with a friend of the user. Responsive to a determination that the second vehicle network node is associated with the friend of the user, the first vehicle network node can provide a notification to the user.

### TECHNICAL FIELD

The disclosed technology relates generally to vehicle-based networks and, more particularly, to vehicle-based social networks.

### BACKGROUND

In today's modem society, vehicles are often a significant aspect of or play a significant role in people's lives. Indeed, people often spend many hours in their cars, trucks, sport utility vehicles (SUVs), minivans, and full-size vans every week during their commutes to work, dropping kids off at school, picking up kids at school, going to the grocery store, and running errands, to name but a few of the many vehicle-based activities that impact peoples' lives.

People often drive their vehicles when going to a social event such as a soccer game or school function, for example. In order to determine whether any friends are currently in the proximity of their vehicle while behind the steering wheel, however, a driver must look for his or her friends' vehicles, call and/or text his or her friends on a mobile communications device such as a cellular phone or smartphone. The former can be distracting, the latter typically requires physical handling of an electronic device, and both make for a sub-optimal and potentially unsafe experience.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 illustrates a first example of a vehicle-based network in accordance with embodiments of the disclosed technology.

FIG. 2 illustrates a second example of a vehicle-based network in accordance with embodiments of the disclosed technology.

FIG. 3 is a block diagram illustrating an example of a portion of a vehicle network node system in accordance with embodiments of the disclosed technology.

FIG. 4 is a flowchart illustrating a first example of a machine-controlled method in accordance with certain embodiments of the disclosed technology.

### DETAILED DESCRIPTION

Certain embodiments of the disclosed technology may include the implementing, e.g., embedding of, an electronic device, referred to herein as a vehicle network node, in each of a number of vehicles within a vehicle network, e.g., an ad-hoc network established between at least two vehicles. Each vehicle network node within the vehicle network may be a stand-alone device that can be easily removed from the vehicle, for example, or it may be integrated as part of a vehicle platform. The vehicle network nodes may communicate with each other using any of a number of near-field communication (NFC) technologies in order to limit the range to an acceptable distance, for example.

Each vehicle network node may be able to detect the other vehicle network nodes and provide a report as to which vehicle network nodes and, thus, which vehicles are currently in the vicinity. Consider an example in which a woman is driving her children to a soccer game in a van equipped with a vehicle network node. As the woman drives her van into the parking lot at die soccer field, the vehicle network node may notify the woman of communication established with other vehicle network nodes, indicating that some of the woman's friends are already at the soccer game based on the presence of the vehicles corresponding to the vehicle network nodes with which the woman's node established communication.

A vehicle network node in accordance with the disclosed technology may have any of a number of different controls and adjustments. For example, a master on/off switch may enable the user to turn the vehicle network node on or off depending on whether the user wishes to use the vehicle network node at that time. The user may take advantage of a timer control to establish certain times during which the user wishes the device to be turned on or off. Another control may allow the user to adjust the range of friend detection so as to enlarge or reduce the radius of the area within which the user wishes to know that a friend has entered.

Certain implementations of the disclosed technology may include a master list of friends that may be used by the vehicle network nodes. The master list may be user-specific and stored by the user's vehicle network node, at a remote device, or both. The user may establish the master list by providing identifiers corresponding to the vehicle network nodes of the user's friends. The master list may be dynamic in that the list may be updated continually and/or at certain defined times automatically or at the direction of the user. For example, if a woman is at her child's soccer game and discovers that one of her friends just got a vehicle network node, the woman may cause the master list to be updated to incorporate her friend's node so that the woman may be alerted when near her friend in the future.

In certain embodiments, a global positioning system (GPS) or other comparable component may be used by or in connection with the vehicle network nodes. For example, a user's vehicle network node may do more than simply notify the user of the potential presence of one or more of the user's friends—the vehicle network node may determine its own geographic location as well as that of the detected vehicle network node(s) and then provide the user with directions to a detected node such that the user may drive closer to the precise present location of the node and, thus, his or her friend.

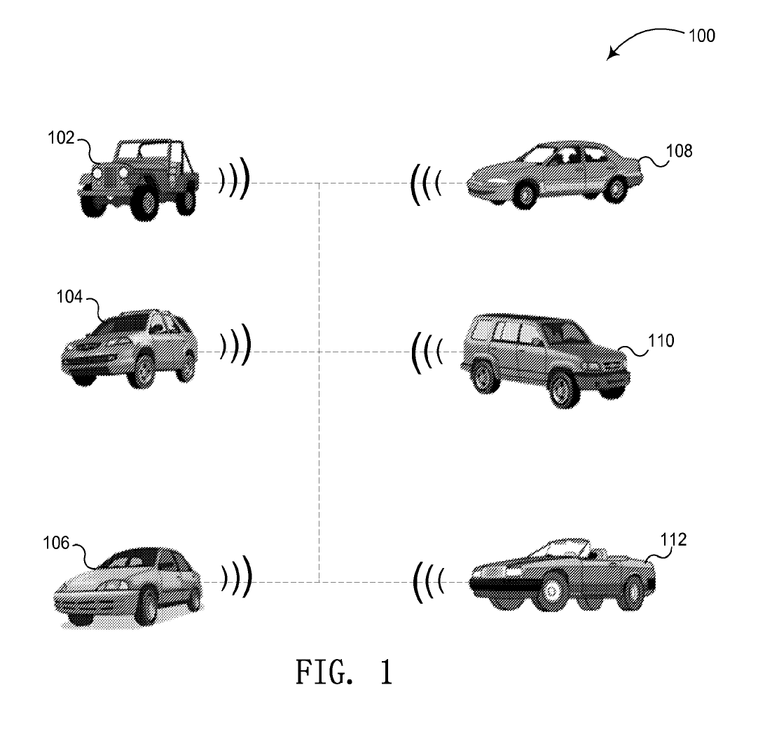

FIG. 1 illustrates a first example of a vehicle-based network 100 in accordance with embodiments of the disclosed technology. In the example, a number of vehicles 102-112 within the network 100 may communicate with each other using any of a number of suitable wireless communication techniques such as near-field communication (NFC), e.g., radio communication, Bluetooth, or Wi-Fi. For example, a jeep 102 may have a vehicle network node installed therein that detects when another vehicle network node installed within a convertible 112 conies within a certain distance of the node in the jeep 102.

In the example, the vehicle network node of the jeep 102 may determine whether the convertible 112 is associated with, e.g., belongs to, one of the user's friends, e.g., by consulting a master list of friends. Responsive to a determination that the convertible 112 is associated with one of the user's friends, the vehicle network node of the jeep 102 may provide the user with a notification that the user's friend may be nearby. In certain embodiments, the vehicle network node of the jeep 102 may even provide the user with a geographic location, e.g., GPS coordinates, of the detected vehicle network node associated with the friend's convertible 112.

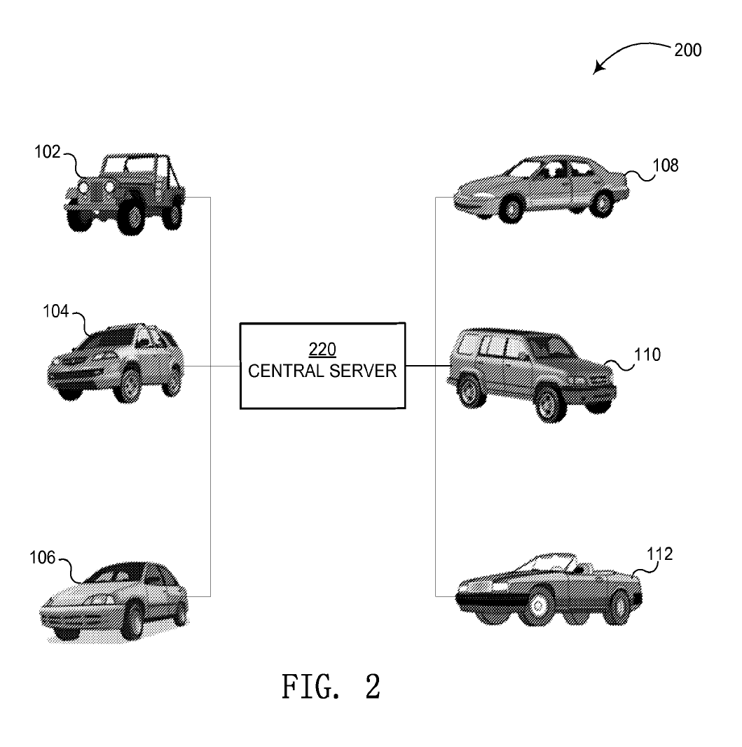

FIG. 2 illustrates a second example of a vehicle-based network 200 in accordance with embodiments of the disclosed technology. The network 200 of FIG. 2 is similar to the network 100 of FIG. 1 except for the addition of a central server 220. In this example, the vehicles 102-112 may have vehicle network nodes that still communicate with each other but, rather than communicate with each other directly, the nodes of the vehicles 102-112 communicate with each other by way of the central server 220. In certain embodiments, the vehicle network nodes of the vehicles 102-112 may communicate with each other directly, through the central server 220, or both.

In certain embodiments, the central server 220 may maintain one or more master lists of friends for any or all of the vehicle network nodes of the vehicles 102-112. In such embodiments, a user may update his or her master list and/or allow the central server 220 to perform updating of his or her list. For example, if a new vehicle network node is entered into at least one master list on which the user's vehicle network node appears, the central server may cause the user's node to prompt the user to specify whether the person/people associated with the new node are to be recognized as friends of the user and, if so, the central server 220 may update the user's master list accordingly.

In certain embodiments, a user may maintain multiple master lists of friends. For example, a user may wish to maintain one list for his or her school-related friends, one list for his or her work-related friends, and one list for his or her church-related friends. There may be certain times of the week, e.g., Sunday morning, when the user is only interested in knowing whether his or her church-related friends, for example, are in the user's vicinity. It should also be noted that there may be some overlap between the lists if one of the user's friends appears on both the user's school-related list and work-related list.

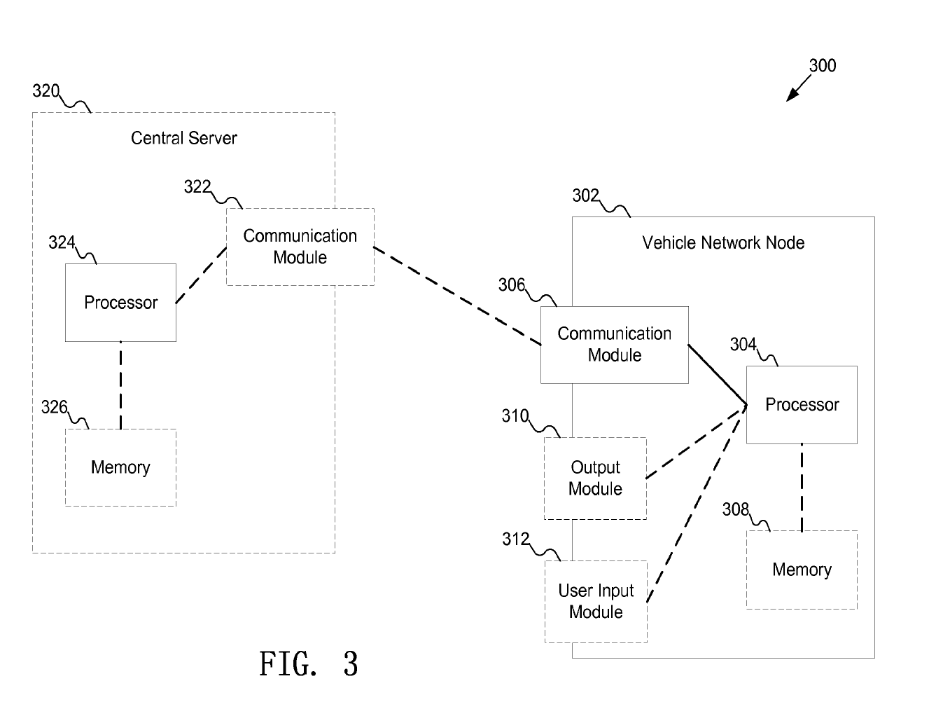

FIG. 3 is a block diagram illustrating an example of a portion 300 of a vehicle network node system in accordance with embodiments of the disclosed technology. In the example, the portion 300 of the vehicle network node system includes a vehicle network node 302 that has a housing and may be implemented in connection with any of the vehicles 102-112 of FIG. 1 and FIG. 2, for example. In certain embodiments, the vehicle network node 302 is integrated with the vehicle itself, e.g., as an original equipment manufacturer (OEM) device. Alternatively, the node 302 may be installable by the user and, in some embodiments, may be detachable such that the user can remove it from the vehicle, e.g., when not in use.

The vehicle network node 302 includes a processor 304 within the housing and a communication module 306 in association with, e.g., integrated with, the housing and configured to communicate with the communication modules of other vehicle network nodes. The communication module 306 may communicate with the other communication modules using virtually any available wireless communication technology such as WiFi or Bluetooth, for example.

The vehicle network node 302 may include an optional memory 308 within the housing for storing the user's master list(s) of friends, for example. The optional memory 308 may also store user preferences and/or parameters pertaining to certain features such as establishing certain days and/or times for the node 302 to be active or inactive or, in the case of multiple master lists, setting a certain list as the default list.

The vehicle network node 302 may also include an optional output module 310 in association with, e.g., integrated with, the housing for visually and/or audibly presenting notifications, alerts, etc. to the user. For example, the output module 310 may include a display for providing visual notifications to the user, e.g., when a friend's vehicle network node has been detected within the user's vicinity or when the detected vehicle network node has left the user's vicinity. Alternatively or in addition thereto, the output module 310 may also include a speaker or other noise/sound-producing component to provide audible notifications such as those noted above.

The vehicle network node 302 may include an optional user input module 312 in association with, e.g., integrated with, the housing. The user input module may include a keyboard, keypad, touchscreen, microphone, or virtually any other component or device or combination thereof that is configured to receive input, e.g., commands or information, from a user. In certain embodiments, the output module 310 and user input module 312 may be the same device or component, e.g., a touchscreen.

In certain embodiments, the vehicle network node system 300 farther includes a central server 320, such as the central server 220 of FIG. 2. The central server 320 has its own communication module 322 for communicating with the communication module 306 of the vehicle network node 302. The central server 320 may have its own processor 324 and memory 326 for perform certain types of processing. In some embodiments, for example, the vehicle network node 302 may detect the present of another node and send information identifying the detected node to the central server 320. The processor 324 of the central server 320 may consult the user's master list stored in the memory 326 of the central server 320 to determine whether the detected node is associated with one of the user's friends and return results of the determination to the node 302 via the node's communication module 306.

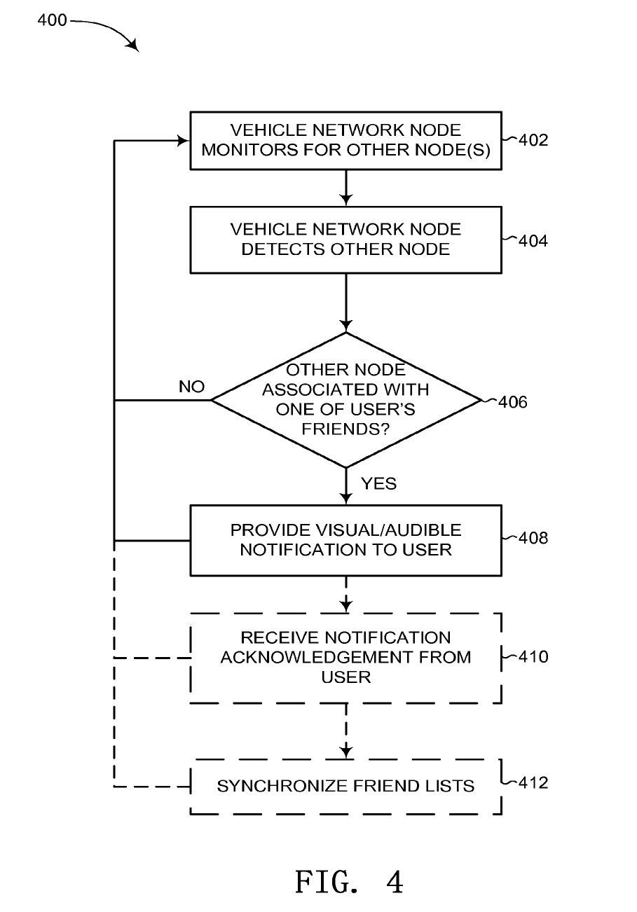

FIG. 4 is a flowchart illustrating a first example of a machine-controlled method 400 in accordance with certain embodiments of the disclosed technology. At 402, a vehicle network node associated with, e.g., belonging to, a user monitors for the presence of other vehicle network nodes that may be associated with other users. In certain embodiments, the vehicle network node may perform such monitoring continuously, at certain time intervals, or during certain days/times. These parameters may be initially configured and modified by the user. Alternatively, the vehicle network node may only perform such monitoring under certain conditions, e.g., when the user's vehicle is running. The node may use any suitable wireless communication technique, e.g., NFC, WiFi, or Bluetooth, for example, to perform the monitoring.

At 404, the user's vehicle network node detects the presence of another vehicle network node that is associated with another user by receiving a ping return or establishing communication with the other node, for example. The vehicle network node may then consult the user's list of friends to determine whether the other vehicle network node is associated with one of the user's friends, as indicated at 406.

Responsive to a determination that the detected vehicle network node is not associated with one of the user's friends, processing of the method 400 may return to 402; otherwise, the vehicle network node provides a notification to the user, as indicated at 408. The notification may include a visual and/or audible notification informing the user of the presence of the user's friend's vehicle network node within the user's vicinity. The notification may also specify which friend(s) is/are presumed to be nearby, e.g., on the basis of the detected node being nearby.

Processing of the method 400 may return to the operation at 402 after the notification has been presented to the user at 408. Alternatively, processing of the method 400 may return to 402 as the notification is being presented or, in other embodiments, after an acknowledgement of the notification is received from the user by the vehicle network node, as indicated at 410.

In an optional operation at 412, the vehicle network node synchronizes the user's master list of friends with a list, of friends associated with, e.g., stored by, the detected vehicle network node. For example, if the detected node is now associated with a third user in addition to—or in place of—the user's friend, the user's vehicle network node may update the user's list of friends accordingly. Alternatively or in addition thereto, the user's vehicle network node may synchronize the user's list of friends with his or her list of friends at a social network site or service such as Facebook or LinkedIn. Processing of the method 400 may return to 402 either during or after the synchronization performed at 412.

Embodiments of the disclosed technology may be incorporated in various types of architectures. For example, certain embodiments may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

What is claimed is:

1. A machine-controlled method, comprising:
a first vehicle network node monitoring for a second vehicle network node, wherein the first vehicle network node is associated with a user;
the first vehicle network node detecting the presence of the second vehicle network node within a specified distance from the first vehicle network node;
determining whether the second vehicle network node is associated with a friend of the user; and
responsive to a determination that the second vehicle network node is associated with the friend of the user, the first vehicle network node providing a notification to the user.

2. The method of claim 1, wherein the determining is performed by the first vehicle network node.

3. The method of claim 1, wherein the determining is performed by a central server.

4. The method of claim 1, wherein the determining comprises consulting a master list of friends of the user.

5. The method of claim 4, further comprising updating the master list of friends based at least in part on the determining.

6. The method of claim 5, wherein the updating comprises associating another friend of the user with the second vehicle network node.

7. The method of claim 4, further comprising synchronizing the master list of friends with a master list of friends of the friend.

8. The method of claim 4, further comprising synchronizing the master list of friends with a listing of friends of the user associated with an online service or website.

9. The method of claim 1, wherein the notification comprises a visual notification, an audible notification, or both.

10. The method of claim 1, further comprising receiving an acknowledgement of the notification from the user.

11. A non-transitory computer-readable medium storing instructions that, when executed by a processor of a first vehicle network node associated with a user, cause the processor to:
monitor for a second vehicle network node;
detect the presence of the second vehicle network node within a specified distance from the first vehicle network node;
determine whether the second vehicle network node is associated with a friend of the user; and
provide a notification to the user responsive to a determination that the second vehicle network node is associated with the friend of the user.

12. The non-transitory computer-readable medium of claim 11, wherein the processor determines whether the second vehicle network node is associated with a friend of the user by consulting a master list of friends of the user.

13. The non-transitory computer-readable medium of claim 12, wherein the instructions further cause the processor to update the master list of friends based at least in part on the determination.

14. A mobile device of a user, comprising:
a housing;
a communication module in association with the housing and configured to communicate with another communication module of another mobile device;
a processor within the housing configured to:
monitor for another mobile device;
detect the presence of the other mobile device within a specified distance from the mobile device; and
determine whether the other mobile device is associated with a friend of the user based at least in part on a listing of friends of the user; and
an output module in association with the housing and configured to provide a notification to the user responsive to a determination that the second vehicle network node is associated with the friend of the user.

15. The mobile device of claim 14, further comprising a memory configured to store the listing of friends of the user.

16. The mobile device of claim 14, further comprising a user input module configured to receive input information from the user.

17. The mobile device of claim 14, wherein the output module comprises a visual output component, and wherein the notification comprises a visual notification.

18. The mobile device of claim 14, wherein the output module comprises an audible output component, and wherein the notification comprises an audible notification.

19. A system, comprising:
a central server configured to store a listing of friends of a user;
a first vehicle network node configured to communicate with the central server; and
a second vehicle network node associated with the user and configured to:
monitor for the first vehicle network node by way of communicating with the central server;
detect the presence of the first vehicle network node within a specified distance from the second vehicle network node by way of communicating with the central server;
determine whether the first vehicle network node is associated with a friend of the user based at least in part on the listing of friends; and
provide a notification to the user responsive to a determination that the first vehicle network node is associated with the friend of the user.

20. The system of claim 19, wherein the notification comprises a visual notification, an audible notification, or both.

21. The system of claim 19, further comprising a third vehicle network node associated with another user and configured to:
monitor for the first vehicle network node or the second vehicle network node by way of communicating with the central server;
detect the presence of the first vehicle network node or the second vehicle network node within a specified distance from the third vehicle network node by way of communicating with the central server;
determine whether the detected vehicle network node is associated with a friend of the other user based at least in part on a listing of friends of the other user; and
provide a notification to the other user responsive to a determination that the detected vehicle network node is associated with the friend of the other user.

22. The system of claim 19, wherein at least one of the first and second vehicle network nodes comprises a mobile electronic device.

23. The system of claim 19, wherein at least one of the first and second vehicle network nodes is fully integrated with a vehicle.
